(19) United States
(12) Patent Application Publication
(10) Pub. No.: US 2006/0222957 A1
(43) Pub. Date: Oct. 5, 2006

(54) BATTERY

(76) Inventors: Tomitaro Hara, Fukushima (JP); Hiroyuki Akashi, Kanagawa (JP); Kenichi Ogawa, Fukushima (JP); Yoshiaki Obana, Fukushima (JP); Yosuke Hosoya, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/278,576

(22) Filed: Apr. 4, 2006

(30) Foreign Application Priority Data
Apr. 4, 2005 (JP) P2005-107784
Jul. 29, 2005 (JP) P2005-222038

(51) Int. Cl. H01M 10/40; H01M 4/58; H01M 4/50; H01M 4/52

(52) U.S. Cl. 429/316; 429/231.95; 429/231.1; 429/224; 429/223; 429/231.6; 429/231.5; 429/220; 429/221; 429/229; 429/231.3

(57) ABSTRACT

A battery capable of improving the energy density and improving the cycle characteristics is provided. The battery includes a spirally wound electrode body, in which a cathode and an anode are wound with a separator and an electrolyte in between. The open circuit voltage in full charge is in the range from 4.25 V to 6.00 V. The electrolyte contains an electrolytic solution and a polymer containing vinylidene fluoride as a component. The polymer containing vinylidene fluoride as a component has high oxidation stability. Therefore, even when the battery voltage is raised, oxidation and decomposition of the electrolyte and the separator can be inhibited.

### CROSS REFERENCES TO RELATED APPLICATIONS

The present invention contains subject matter related to Japanese Patent Applications JP 2005-107784 filed in the Japanese Patent Office on Apr. 4, 2005 and JP2005-222038 filed in the Japanese Patent Office on Jul. 29, 2005, the entire contents of which being incorporated herein by reference.

### BACKGROUND OF THE INVENTION

1. Field of the Invention

The present invention relates to a battery, in which the open circuit voltage in a full charge state per a pair of the cathode and the anode is 4.25 V or more.

2. Description of the Related Art

In recent years, many portable electronic devices such as combination cameras, mobile phones, and portable computers have been introduced, and their size and weight have been reduced. In these electronic devices, in addition to the size reduction, multifunction and sophistication have been promoted. In the result, the power consumption thereof is not always lowered. In practice, the usage time tends to become longer because of the multifunction. Users desire to use such portable electronic devices for a longer time. Accordingly, a higher energy density of lithium ion secondary batteries widely used as a power source for the portable electronic devices has been desired.

In general, in traditional lithium ion secondary batteries, lithium cobaltate is used for the cathode, a carbon material is used for the anode, and the operating voltage is in the range from 4.2 V to 2.5 V. In such a lithium ion secondary batteries operating at 4.2 V at maximum, for the cathode active material such as lithium cobaltate used for the cathode, only about 60% of the theoretical capacity is utilized. Therefore, in principle, it is possible to utilize the remaining capacity by further increasing the charging voltage. In fact, it is known that a high energy density is realized by setting the voltage in charging to 4.25 V or more (refer to International Publication No. W003/0197131).

### SUMMARY OF THE INVENTION

However, in the battery setting the charging voltage over 4.2 V, oxidative atmosphere particularly in the vicinity of the cathode surface is intensified. In the result, the nonaqueous electrolyte material and the separator, which physically contact the cathode, are easily oxidized and decomposed. Thereby, there is a disadvantage that the internal resistance is increased, and the battery characteristics such as cycle characteristics are lowered.

In view of the foregoing disadvantage, in the present invention, it is desirable to provide a battery capable of improving the battery characteristics such as cycle characteristics even when the charging voltage is set to over 4.2 V.

According to an embodiment of the present invention, there is provided a battery in which a cathode and an anode are oppositely arranged with an electrolyte in between, wherein an open circuit voltage in a full charge state per a pair of the cathode and the anode is in the range from 4.25 V to 6.00 V, and the electrolyte contains an electrolytic solution and a polymer containing vinylidene fluoride as a component.

According to the battery of the embodiment of the present invention, since the open circuit voltage in a full charge state per a pair of the cathode and the anode is in the range from 4.25 V to 6.00 V, a high energy density can be obtained. Further, since the electrolyte contains a polymer containing vinylidene fluoride as a component, oxidation and decomposition reaction in the vicinity of the cathode surface can be inhibited, and the battery characteristics such as cycle characteristics can be improved.

Other and further objects, features and advantages of the invention will appear more fully from the following description.

### BRIEF DESCRIPTION OF THE DRAWINGS

FIG. 1 is an exploded perspective view showing a structure of a secondary battery according to an embodiment of the present invention;

FIG. 2 is a cross section taken along line I-I of a spirally wound electrode body shown in FIG. 1;

FIG. 3 is a characteristics diagram showing a relation between cycle number and discharge capacity retention ratio when a charging voltage is 4.25 V;

FIG. 4 is a characteristics diagram showing a relation between cycle number and discharge capacity retention ratio when a charging voltage is 4.55 V;

FIG. 5 is a characteristics diagram showing a relation between cycle number and discharge capacity retention ratio when a charging voltage is 4.20 V;

FIG. 6 is a characteristics diagram showing a relation between cycle number and discharge capacity retention ratio according to charging voltage;

FIG. 7 is another characteristics diagram showing a relation between cycle number and discharge capacity retention ratio according to charging voltage;

FIG. 8 is still another characteristics diagram showing a relation between cycle number and discharge capacity retention ratio according to charging voltage; and

FIG. 9 is still another characteristics diagram showing a relation between cycle number and discharge capacity retention ratio according to charging voltage.

### DETAILED DESCRIPTION OF THE PREFERRED EMBODIMENT

An embodiment of the present invention will be hereinafter described in detail with reference to the drawings.

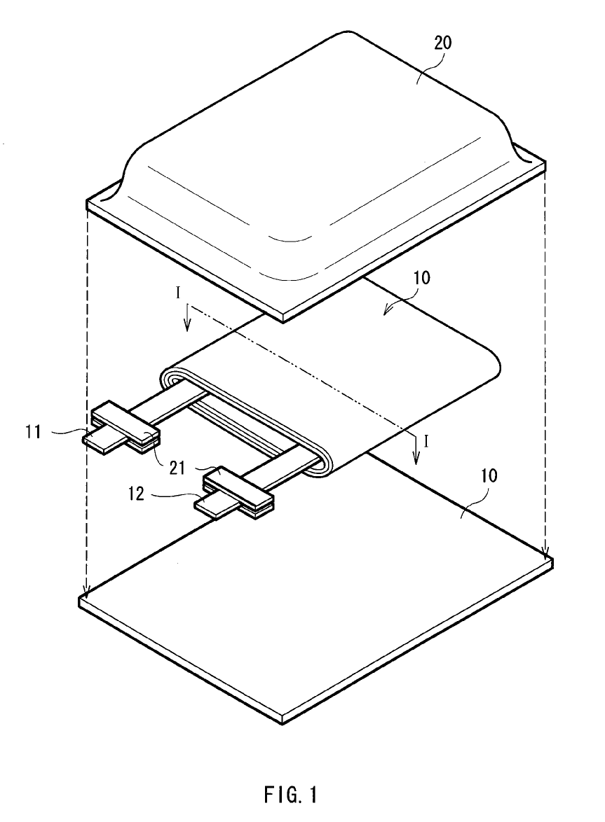

FIG. 1 shows a structure of a secondary battery according to an embodiment of the present invention. In the secondary battery, lithium (Li) is used as an electrode reactant. For example, the secondary battery has a structure in which a spirally wound electrode body 10 on which a cathode lead 11 and an anode lead 12 are attached is contained inside a film package member 20.

The cathode lead 11 and the anode lead 12 are respectively directed from inside to outside of the package member 20 in the same direction, for example. The cathode lead 11 and the anode lead 12 are respectively made of, for example, a metal material such as aluminum (Al), copper (Cu), nickel (Ni), and stainless, and are in the shape of thin plate or mesh.

The package member 20 is made of a rectangular aluminum laminated film in which, for example, a nylon film, an aluminum foil, and a polyethylene film are bonded together in this order. The package member 20 is, for example, arranged so that the polyethylene film side and the spirally wound electrode body 10 are opposed, and the respective outer edges are contacted to each other by fusion bonding or an adhesive. Adhesive films 21 to protect from outside air intrusion are inserted between the package member 20 and the cathode lead 11, the anode lead 12. The adhesive film 21 is made of a material having contact characteristics to the cathode lead 11 and the anode lead 12, for example, is made of a polyolefin resin such as polyethylene, polypropylene, modified polyethylene, and modified polypropylene.

The exterior member 20 may be made of a laminated film having other structure, a high molecular weight film such as polypropylene, or a metal film, instead of the foregoing aluminum laminated film.

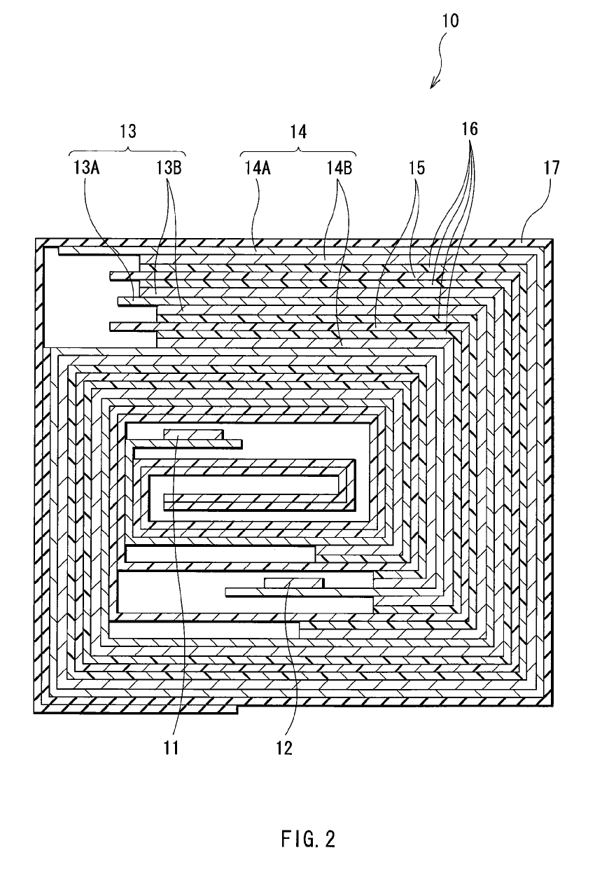

FIG. 2 shows a cross sectional structure taken along line I-I of the spirally wound electrode body 10 shown in FIG. 1. In the spirally wound electrode body 10, a pair of a cathode 13 and an anode 14 is layered with a separator 15 and an electrolyte 16 in between and wound. The cathode 13 and the anode 14 are oppositely arranged with the separator 15 and the electrolyte 16 in between. The outermost periphery of the spirally wound electrode body 10 is protected by a protective tape 17.

The cathode 13 has a structure in which, for example, a cathode active material layer 13B is provided on the both faces of a cathode current collector 13A having a pair of opposed faces. Though not shown, the cathode active material layer 13B may be provided on only one face of the cathode current collector 13A. The cathode current collector 13A is made of a metal foil such as an aluminum foil, a nickel foil, and a stainless foil. The cathode active material layer 13B contains, for example, as a cathode active material, one or more cathode materials capable of inserting and extracting lithium, which is an electrode reactant. If necessary, the cathode active material layer 13B contains an electrical conductor such as graphite and a binder such as polyvinylidene fluoride.

As a cathode material capable of inserting and extracting lithium, for example, a lithium-containing compound such as a lithium oxide, a lithium phosphorous oxide, a lithium sulfide, and an intercalation compound containing lithium is appropriate. Two or more thereof may be used by mixing. In order to improve the energy density, a lithium-containing compound which contains lithium, transition metal elements, and oxygen (O) is preferable. Specially, a lithium-containing compound which contains at least one from the group consisting of cobalt (Co), nickel, manganese (Mn), and iron (Fe) as a transition metal element is more preferable. As such a lithium-containing compound, for example, a bedded salt type lithium complex oxide shown in Chemical formula 1, Chemical formula 2, or Chemical formula 3; a spinel type lithium complex oxide shown in Chemical formula 4; an olivine type lithium complex phosphate shown in Chemical formula 5 or the like can be cited. Specifically, LiNi_{0.50}CO_{0.20}Mn_{0.30}O₂, LiₐCoO₂ (a≈1), Li_{b}NiO₂ (b≈1), Li_{c1}Ni_{c2}Co_{1-c2}O₂ (c1≈1, 0<c2<1), Li_{d}Mn₂O₄ (d≈1), LiₑFePO₄ (e≈1) or the like can be cited.
Li_{f}Mn_{(1-g-h)}Ni_{g}M1ₕO₍₂₋ⱼ₎Fₖ (Chemical formula 1)

In the formula, M1 represents at least one from the group consisting of cobalt, magnesium (Mg), aluminum, boron (B), titanium (Ti), vanadium (V), chromium (Cr), iron, copper, zinc (Zn), zirconium (Zr), molybdenum (Mo), tin (Sn), calcium (Ca), strontium (Sr), and tungsten (W). f, g, h, j, and k are values in the range of 0.8≦f≦1.2, 0<g<0.5, 0≦h≦0.5, g+h<1, −0.1≦j≦0.2, and 0≦k≦0.1. The composition of lithium varies according to charge and discharge states. A value of f represents the value in a full discharge state.
LiₘNi₍₁₋ₙ₎M2ₙO₍₂₋ₚ₎F_{q} (Chemical formula 2)

In the formula, M2 represents at least one from the group consisting of cobalt, manganese, magnesium, aluminum, boron, titanium, vanadium, chromium, iron, copper, zinc, molybdenum, tin, calcium, strontium, and tungsten. m, n, p, and q are values in the range of 0.8≦m≦1.2, 0.005≦n≦0.5, −0.1≦p≦0.2, and 0≦q≦0.1. The composition of lithium varies according to charge and discharge states. A value of m represents the value in a full discharge state.
LiᵣCo₍₁₋ₛ₎M3ₛO₍₂₋ₜ₎Fᵤ (Chemical formula 3)

In the formula, M3 represents at least one from the group consisting of nickel, manganese, magnesium, aluminum, boron, titanium, vanadium, chromium, iron, copper, zinc, molybdenum, tin, calcium, strontium, and tungsten. r, s, t, and u are values in the range of 0.8≦r≦1.2, 0≦s<0.5, −0.1≦t≦0.2, and 0≦u≦0.1. The composition of lithium varies according to charge and discharge states. A value of r represents the value in a full discharge state.
LiᵥMn_{2-w}M4_{w}OₓF_{y} (Chemical formula 4).

In the formula, M4 represents at least one from the group consisting of cobalt, nickel, magnesium, aluminum, boron, titanium, vanadium, chromium, iron, copper, zinc, molybdenum, tin, calcium, strontium, and tungsten. v, w, x, and y are values in the range of 0.9≦v≦1.1, 0≦w≦0.6, 3.7≦x≦4.1, and 0≦y≦0.1. The composition of lithium varies according to charge and discharge states. A value of v represents the value in a full discharge state.
Li_{z}M5PO₄ (Chemical formula 5)

In the formula, M5 represents at least one from the group consisting of cobalt, manganese, iron, nickel, magnesium, aluminum, boron, titanium, vanadium, niobium, copper, zinc, molybdenum, calcium, strontium, tungsten, and zirconium. z is a value in the range of 0.9≦z≦1.1. The composition of lithium varies according to charge and discharge states. A value of z represents the value in a full discharge state.

As a cathode material capable of inserting and extracting lithium, in addition to the foregoing, an inorganic compound not containing lithium such as MnO₂, V₂O₅, V₆O₁₃, NiS, and MoS can be cited.

The anode 14 has a structure in which an anode active material layer 14B is provided on the both faces of an anode current collector 14A having a pair of opposed faces. Though not shown, the anode active material layer 14B may be provided only on one face of the anode current collector 14A. The anode current collector 14A is made of, for example, a metal foil such as a copper foil, a nickel foil, and a stainless foil, which have favorable electrochemical stability, electrical conductivity, and mechanical strength. In particular, the copper foil is most preferable, since the copper foil has high electrical conductivity.

The anode active material layer 14B contains, as an anode active material, one or more anode materials capable of inserting and extracting lithium. If necessary, the anode active material layer 14B contains a binder similar to of the cathode active material layer 13B.

As an anode material capable of inserting and extracting lithium, for example, a carbon material such as non-graphitizable carbon, graphitizable carbon, graphite, pyrolytic carbons, cokes, glassy carbons, an organic high molecular weight compound fired body, carbon fiber, and activated carbon can be cited. Of the foregoing, cokes include pitch cokes, needle cokes, petroleum cokes and the like. The organic high molecular weight compound fired body is obtained by firing and carbonizing a high molecular weight material such as a phenol resin and a furan resin at appropriate temperatures, and some thereof are categorized as non-graphitizable carbon or graphitizable carbon. As a high molecular weight material, polyacetylene, polypyrrole or the like can be cited. These carbon materials are preferable, since the crystal structure change generated in charge and discharge is very small, a high charge and discharge capacity can be obtained, and favorable cycle characteristics can be obtained. In particular, graphite is preferable, since the electrochemical equivalent is large, and a high energy density can be obtained. Further, non-graphitizable carbon is preferable since superior characteristics can be obtained. Furthermore, a material with a low charge and discharge potential, specifically a material with the charge and discharge potential close to of lithium metal is preferable, since a high energy density of the battery can be thereby easily realized.

As an anode material capable of inserting and extracting lithium, a material, which is capable of inserting and extracting lithium, and contains at least one of metal elements and metalloid elements as an element can be also cited. When such a material is used, a high energy density can be obtained. In particular, such a material is more preferably used together with a carbon material, since a high energy density can be obtained, and superior cycle characteristics can be obtained. Such an anode material may be a simple substance, an alloy, or a compound of a metal element or a metalloid element, or may have one or more phases thereof at least in part. In the present invention, alloys include an alloy containing one or more metal elements and one or more metalloid elements, in addition to an alloy including two or more metal elements. Further, an alloy may contain nonmetallic elements. The texture thereof includes a solid solution, a eutectic crystal (eutectic mixture), an intermetallic compound, and a texture in which two or more thereof coexist.

As a metal element or a metalloid element composing the anode material, magnesium, boron, aluminum, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd), or platinum (Pt) can be cited. They may be crystalline or amorphous.

Specially, as the anode material, a material containing a metal element or a metalloid element of Group 4B in the short period periodic table as an element is preferable. A material containing at least one of silicon and tin as an element is particularly preferable. Silicon and tin have a high ability to insert and extract lithium, and can provide a high energy density.

As an alloy of tin, for example, an alloy containing at least one from the group consisting of silicon, nickel, copper, iron, cobalt, manganese, zinc, indium, silver, titanium, germanium, bismuth, antimony (Sb), and chromium as a second element other than tin can be cited. As an alloy of silicon, for example, an alloy containing at least one from the group consisting of tin, nickel, copper, iron, cobalt, manganese, zinc, indium, silver, titanium, germanium, bismuth, antimony, and chromium as a second element other than silicon can be cited.

As a compound of tin or a compound of silicon, for example, a compound containing oxygen or carbon (C) can be cited. In addition to tin or silicon, the compound may contain the foregoing second element.

As an anode material capable of inserting and extracting lithium, other metal compound or a high molecular weight material can be further cited. As other metal compound, an oxide such as MnO₂, V₂O₅, and V₆O₁₃; a sulfide such as NiS and MoS; or a lithium nitride such as LiN₃ can be cited. As a high molecular weight material, polyacetylene, polyaniline, polypyrrole or the like can be cited.

Further, in the secondary battery, the open circuit voltage in full charge (that is, battery voltage) is designed to fall within the range from 4.25 V to 6.00 V by adjusting the amounts of the cathode active material and the anode active material. Thereby, a high energy density can be obtained. For example, in the case that the open circuit voltage in full charge is 4.25 V or more, the lithium extraction amount per unit weight becomes larger than in the battery with the open circuit voltage in full charge of 4.2 V even though the same cathode active material is used. Accordingly, the amount of the anode active material is adjusted.

The separator 15 is made of a porous film made of a synthetic resin such as polytetrafluoroethylene, polypropylene, and polyethylene, or a ceramics porous film. The separator 15 may have a structure in which two or more porous films as the foregoing porous films are layered. Specially, the polyolefin porous film is preferable, since such a film has superior short circuit prevention effect and can improve battery safety by shutdown effect.

The electrolyte 16 contains an electrolytic solution and a high molecular weight compound holding the electrolytic solution, and is so-called gelatinous. The electrolytic solution contains a solvent and an electrolyte salt.

As a solvent, for example, a nonaqueous solvent such as lactone such as γ-butyrolactone, γ-valerolactone, δ-valerolactone, and c-caprolactone; ester carbonate such as ethylene carbonate, propylene carbonate, butylene carbonate, vinylene carbonate, dimethyl carbonate, ethyl methyl carbonate, and diethyl carbonate; ether such as 1,2-dimethoxy ethane, 1-ethoxy-2-methoxy ethane, 1,2-diethoxy ethane, tetrahydrofuran, and 2-methyl tetrahydrofuran; ester such as methyl propionate; sulfoxide such as dimethyl sulfoxide; nitrile such as acetonitrile; sulfolane; phosphoric acids; phosphoric ester; pyrrolidone; and their derivatives can be cited. One of the solvents may be used singly, or two or more thereof may be used by mixing.

For the electrolyte salt, for example, a lithium salt can be cited. One of lithium salts may be used singly, or two or more thereof may be used by mixing. As a lithium salt, LiPF₆, LiBF₄, LiAsF₆, LiClO₄, LiClO₃, LiBrO₃, LiIO₃, LiNO₃, LiCH₃COO, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBr, LiI, difluoro[oxolate-O—O′]lithium borate, lithium bis oxalate borate or the like can be cited. Specially, LiPF₆ and LiBF₄ are preferable, since LiPF₆ and LiBF₄ have high oxidation stability.

The high molecular weight compound contains a polymer containing vinylidene fluoride as a component. Thereby, the oxidation stability of the electrolyte 16 can be improved, and oxidation and decomposition reaction in the vicinity of the cathode 13 can be inhibited even when the battery voltage is raised. The polymer may be polyvinylidene fluoride or a copolymer containing vinylidene fluoride as a component. One polymer may be used singly, or two or more polymers may be used by mixing. Further, other one or more high molecular weight compound may be mixed with the polymer containing vinylidene fluoride as a component.

As a copolymer containing vinylidene fluoride as a component, a copolymer containing, for example, hexafluoropropylene, monoester of unsaturated dibasic acid such as monomethyl ester maleate, ethylene halide such as ethylene chloride trifluoride, cyclic ester carbonate of unsaturated compound such as vinylene carbonate, or epoxy group containing acryl vinyl monomer as other component can be cited. Other component may be one or more.

Specially, as the polymer, a copolymer containing vinylidene fluoride and hexafluoropropylene as a component is preferable. Such a copolymer has high contact characteristics and impregnation characteristics to the electrode, and provides superior battery characteristics. In particular, the block copolymer thereof is preferable, since such a block copolymer can provide high characteristics. The copolymerization amount of hexafluoropropylene in the copolymer is preferably 7 wt % or less. When the copolymerization amount of hexafluoropropylene is too large, crystallinity of the base material polymer is changed, and the mechanical strength and the ability of holding the electrolytic solution are lowered.

The electrolyte 16 is preferably sandwiched at least between the cathode 13 and the separator 15. As described above, the electrolyte 16 has high oxidation stability since the electrolyte 16 contains a polymer containing vinylidene fluoride as a component. Therefore, the electrolyte 16 can inhibit the separator 15 from being contacted with the cathode 13 and oxidized and decomposed. In this embodiment, as shown in FIG. 2, the electrolyte 16 is provided between the cathode 13 and the separator 15, and between the anode 14 and the separator 15, respectively.

The secondary battery can be manufactured, for example, as follows.

First, for example, the cathode 13 is formed by forming the cathode active material layer 13B on the cathode current collector 13A. The cathode active material layer 13B is formed, for example, as follows. A cathode material capable of inserting and extracting lithium, an electrical conductor, and a binder are mixed to prepare a cathode mixture, which is dispersed in a solvent such as N-methyl-2-pyrrolidone to obtain a paste cathode mixture slurry. Then, the cathode current collector 13A is coated with the cathode mixture slurry, the solvent is dried, and the resultant is compression-molded by a rolling press machine. Consequently, the cathode active material layer 13B is formed.

Further, for example, the anode 14 is formed by forming the anode active material layer 14B on the anode current collector 14A. The anode active material layer 14B may be formed by, for example, any of vapor-phase deposition method, liquid-phase deposition method, firing method, coating, and combination of two or more of these methods. As vapor-phase deposition method, for example, physical deposition method or chemical deposition method can be used. Specifically, vacuum vapor deposition method, sputtering method, ion plating method, laser ablation method, thermal CVD (Chemical Vapor Deposition) method, plasma CVD method and the like are available. As liquid-phase deposition method, a known technique such as electrolytic plating and electroless plating is available. For firing method, a known technique such as atmosphere firing method, reactive firing method, and hot press firing method is available. In the case of coating, the anode active material layer 14B can be formed in the same manner as in the cathode 13.

Next, the electrolyte 16 is formed by coating the cathode 13 and the anode 14 with a precursor solution containing an electrolytic solution, a high molecular weight compound, and a mixed solvent, and then volatilizing the mixed solvent. After that, the cathode lead 11 is attached to the cathode current collector 13A, and the anode lead 12 is attached to the anode current collector 14A. Subsequently, the cathode 13 and the anode 14, which are formed with the electrolyte 16, are layered with the separator 15 in between. The lamination is wound in the longitudinal direction and the protective tape 17 is adhered to the outermost periphery to form the spirally wound electrode body 10. Finally, for example, the spirally wound electrode body 10 is sandwiched between the package members 20, and the outer edges of the package member 20 are contacted by thermal fusion bonding or the like, and the spirally wound electrode body 10 is enclosed. Then, the adhesive films 21 are inserted between the cathode lead 11, the anode lead 12 and the package member 20. The secondary battery shown in FIGS. 1 and 2 is thereby obtained.

In the secondary battery, when charged, lithium ions are extracted from the cathode active material layer 13B and inserted in the anode active material layer 14B through the electrolyte 16. Next, when discharged, the lithium ions are extracted from the anode active material layer 14B, and inserted in the cathode active material layer 13B through the electrolyte 16. In this embodiment, the open circuit voltage in full charge is high, 4.25 V or more, and the vicinity of the cathode 13 is in the strong oxidizing atmosphere. However, since the electrolyte 16 contains a polymer containing vinylidene fluoride as a component, oxidation and decomposition reaction in the vicinity of the cathode 13 is inhibited.

As above, in this embodiment, since the open circuit voltage in full charge per a pair of the cathode 21 and the anode 22 is in the range from 4.25 V to 6.00 V. Therefore, a high energy density can be obtained. Further, since the electrolyte 16 contains a polymer containing vinylidene fluoride as a component, oxidation and decomposition reaction in the vicinity of the cathode 13 is inhibited even when the open circuit voltage in full charge is raised. Consequently, the battery characteristics such as cycle characteristics can be improved.

### EXAMPLES

Further, specific examples of the present invention will be described in detail.

### Examples 1-1 and 1-2

Secondary batteries shown in FIGS. 1 and 2 were fabricated. First, a cathode active material was formed as follows. As an aqueous solution, commercially available nickel nitrate, cobalt nitrate, and manganese nitrate were mixed so that the ratios of Ni, Co, and Mn became 0.333, 0.334, and 0.333, respectively. After that, while the mixture was sufficiently stirred, ammonia water was dropped into the mixed solution to obtain a complex hydroxide. The complex hydroxide and lithium hydroxide were mixed, the mixture was fired for 10 hours at 900 deg C. in the oxygen air current, and pulverized to obtain lithium complex oxide powder as a cathode active material. When the obtained lithium complex oxide powder was analyzed by Atomic Absorption Spectrometry (ASS), the composition of LiNi_{0.33}Co_{0.33}Mn_{0.330}₂ was verified. Further, when the particle diameter was measured by laser diffraction method, the average particle diameter was 13 μm. Further, when X-ray diffraction measurement was conducted, it was confirmed that the measurement result was similar to the pattern of LiNiO₂ listed in No. 09-0063 of the ICDD (International Center for Diffraction Data) card, and a bedded salt structure similar to of LiNiO₂ was formed. Furthermore, when the obtained lithium complex oxide powder was observed by Scanning Electron Microscope (SEM), spherical particles in which primary particles being from 0.1 μm to 5 μm in size were agglomerated were observed.

Next, 86 wt % of the obtained LiNi_{0.33}Co_{0.33}Mn_{0.33}O₂ powder, 10 wt % of artificial graphite powder as an electrical conductor, and 4 wt % of polyvinylidene fluoride as a binder were mixed. The mixture was dispersed in N-methyl-2-pyrrolidone as a solvent to obtain cathode mixture slurry. Subsequently, the both faces of the cathode current collector 13A made of a strip-shaped aluminum foil being 20 μm thick were uniformly coated with the cathode mixture slurry, which was dried and compress-molded by a rolling press machine to form the cathode active material layer 13B and thereby form the cathode 13.

Further, spheroidal graphite powder as an anode active material was prepared. 90 wt % of the spheroidal graphite powder and 10 wt % of a copolymer of vinylidene fluoride and hexafluoropropylene as a binder were mixed. The mixture was dispersed in N-methyl-2-pyrrolidone as a solvent to obtain anode mixture slurry. Next, the both faces of the anode current collector 14A made of a strip-shaped copper foil being 10 μm thick were uniformly coated with the anode mixture slurry, which was provided with hot press molding to form the anode active material layer 14B and thereby form the anode 14. For the cathode 13 and the anode 14, the coating amounts of the cathode active material and the anode active material were adjusted so that the ratio of the theoretical lithium extraction amount per unit area of the cathode 13 and the theoretical lithium insertion amount per unit area of the anode 14 opposed to the cathode 13 became cathode/anode=0.95 in a predetermined charging voltage. Then, the charging voltage was 4.25 V in Example 1-1, and 4.55 in Example 1-2.

Subsequently, 42.5 wt % of ethylene carbonate, 42.5 wt % of propylene carbonate, and 15 wt % of LiPF₆ were mixed to prepare an electrolytic solution. 30 parts by weight of the electrolytic solution and 10 parts by weight of a block copolymer of vinylidene fluoride and hexafluoropropylene with the weight average molecular weight of about 0.6 million were mixed and dissolved by using a mixed solvent to form a precursor solution. After that, the both faces of the cathode 13 and the anode 14 were coated with the precursor solution, the mixed solution was volatilized, and the electrolyte 16 was respectively formed. Next, the cathode lead 11 was attached to the cathode current collector 13A, and the anode lead 12 was attached to the anode current collector 14A.

Subsequently, the cathode 13 and the anode 14, which are formed with the electrolyte 16, were layered with the separator 15 made of a microporous polyolefin film in between and wound to form the spirally wound electrode body 10. After that, the spirally wound electrode body 10 was sandwiched between the package members 20 made of an aluminum laminated film. The peripheral edges of the package member 20 were contacted to each other, and the spirally wound electrode body 10 was enclosed. Thereby, the secondary batteries of Examples 1-1 and 1-2 were obtained.

As Comparative examples 1-1 and 1-2 relative to Examples 1-1 and 1-2, secondary batteries were fabricated in the same manner as in Examples 1-1 and 1-2, except that the electrolytic solution was directly injected into the package member without using a polymer containing vinylidene fluoride as a component. Further, as Comparative examples 1-3 and 1-4, secondary batteries were fabricated in the same manner as in Examples 1-1 and 1-2, except that the coating amounts of the cathode active material and the anode active material were adjusted as the charging voltage of 4.20 V, and further except that in Comparative example 1-4, the electrolytic solution was directly injected into the package member without using a polymer.

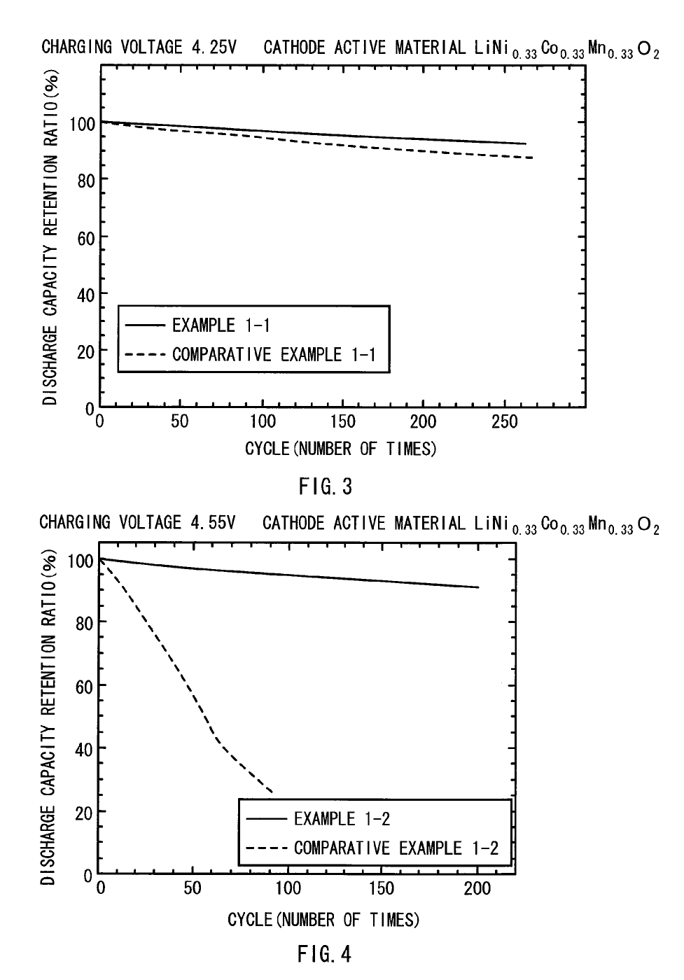

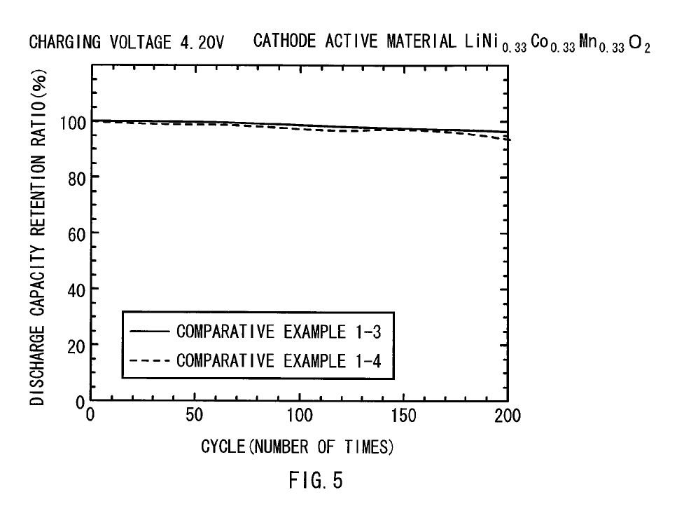

For the fabricated secondary batteries of Examples 1-1 and 1-2, and Comparative examples 1-1 to 1-4, charge and discharge were performed, and the discharge capacity retention ratio of each cycle to the discharge capacity at the first cycle was examined. Then, for charging, at 23 deg C., after constant current charge was performed at a current value at which the theoretical capacity is wholly discharged in 2 hours until the battery voltage reached a specific value, constant voltage charge was performed for 5 hours at a specific constant voltage to obtain a full charge state. The specific voltage value was 4.25 V in Example 1-1 and Comparative example 1-1, 4.55 V in Example 1-2 and Comparative example 1-2, and 4.20 V in Comparative examples 1-3 and 1-4. For discharge, at 23 deg C., constant current discharge was performed at a current value at which the theoretical capacity is wholly discharged in 2 hours until the battery voltage reached 3.0 V and a full discharge state was obtained. The obtained results are shown in FIGS. 3 to 5.

As shown in FIGS. 3 to 5, in Examples 1-1 and 1-2, and Comparative examples 1-1 and 1-2, in which the charging voltage was 4.25 V or more, lowering of the discharge capacity could be smaller in Examples 1-1 and 1-2 using the polymer containing vinylidene fluoride as a component compared to in Comparative examples 1-1 and 1-2 using the electrolytic solution directly. In particular, when comparing Example 1-2 to Comparative example 1-2, in which the charging voltage was high, 4.55 V, the discharge capacity retention ratio could be significantly improved in Example 1-2 than in Comparative example 1-2. Meanwhile, in Comparative examples 1-3 and 1-4, in which the charging voltage was 4.20 V, the discharge capacity retention ratios were almost equal to each other regardless of usage of the polymer.

That is, it was found that as long as the polymer containing vinylidene fluoride as a component was used, the oxidation stability of the electrolyte 16 could be improved, and superior cycle characteristics could be obtained even when the open circuit voltage in full charge was 4.25 V or more.

### Examples 2-1, 2-2, 3-1, and 3-2

Secondary batteries were fabricated in the same manner as in Examples 1-1 and 1-2, except that as a cathode active material, LiCoO₂ powder was used in Examples 2-1 and 2-2 and LiCo_{0.98}Al_{0.01}Mg_{0.01}O₂ powder was used in Examples 3-1 and 3-2; and the predetermined charging voltage was 4.40 V in Example 2-1, 4.55 V in Example 2-2, 4.40 V in Example 3-1, and 4.55 V in Example 3-2.

As Comparative examples 2-1 and 2-2 relative to Examples 2-1 and 2-2, and as Comparative examples 3-1 and 3-2 relative to Examples 3-1 and 3-2, secondary batteries were fabricated in the same manner as in Examples 2-1 and 2-2 or Examples 3-1 and 3-2, except that the electrolytic solution was directly injected into the package member without using a polymer containing vinylidene fluoride as a component. Further, as Comparative examples 2-3 and 2-4, and Comparative examples 3-3 and 3-4, batteries were fabricated in the same manner as in Examples 2-1 and 2-2 or Examples 3-1 and 3-2, except that the coating amounts of the cathode active material and the anode active material were adjusted as the charging voltage of 4.20 V, and further except that in Comparative examples 2-4 and 3-4, the electrolytic solution was directly injected into the package member without using a polymer.

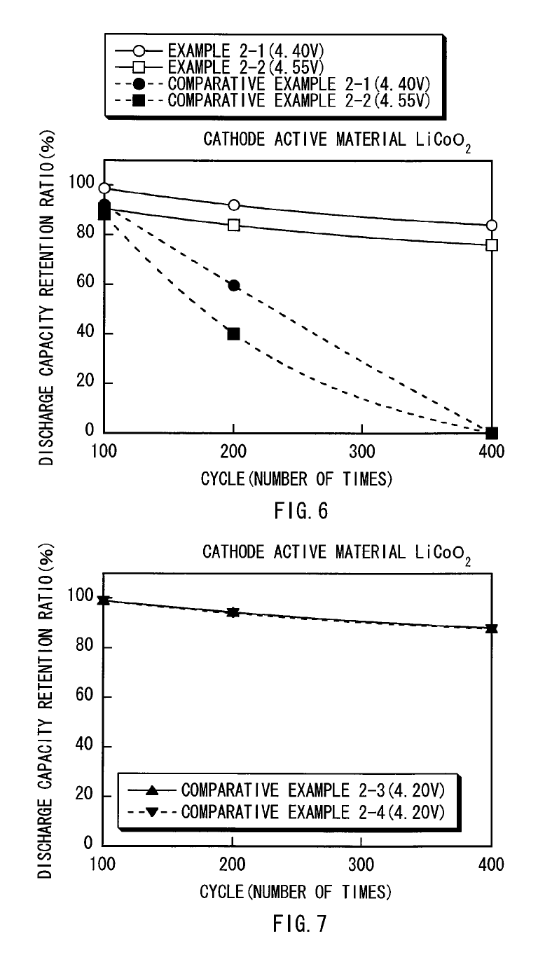

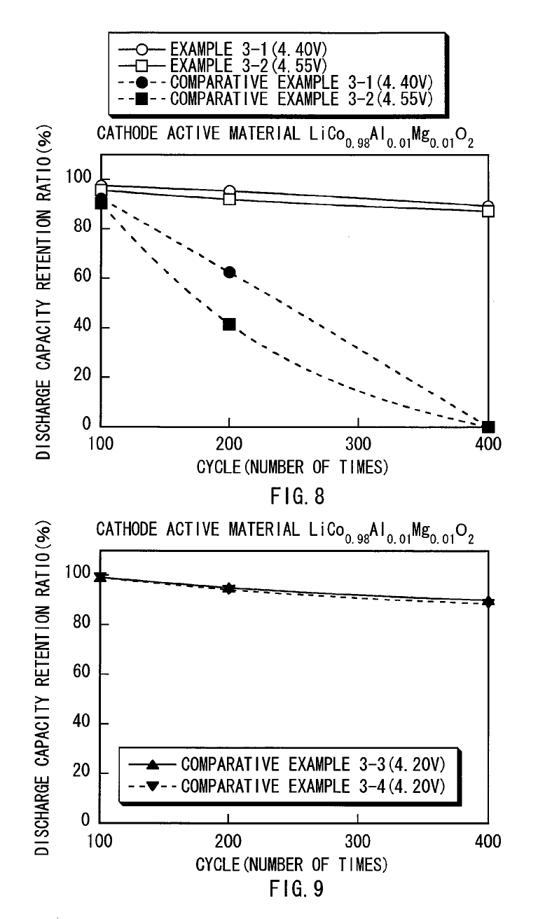

For the fabricated secondary batteries of Examples 2-1, 2-2, 3-1, and 3-2, and Comparative examples 2-1 to 2-4 and 3-1 to 3-4, charge and discharge were performed in the same manner as in Examples 1-1 and 1-2, and the discharge capacity retention ratio of each cycle to the discharge capacity at the first cycle was examined. The specific voltage value in charging was 4.40 V in Examples 2-1 and 3-1, and Comparative examples 2-1 and 3-1; 4.55 V in Examples 2-2 and 3-2, and Comparative examples 2-2 and 3-2; and 4.20 V in Comparative examples 2-3, 2-4, 3-3, and 3-4. The obtained results are shown in Tables 1 and 2, and FIGS. 6 to 9.

TABLE 1

| | | | | Discharge capacity | | |
|---|---|---|---|---|---|---|
| | | | | retention ratio | | |
| | Charging | Cathode | | (%) | | |
| | voltage | active | | 100th | 200th | 400th |
| | (V) | material | Electrolyte | cycle | cycle | cycle |
| Example 2-1 | 4.40 | LiCoO₂ | Polymer | 98.6 | 92.1 | 84.0 |
| Example 2-2 | 4.55 | | contained | 90.6 | 84.0 | 76.0 |
| Comparative | 4.40 | LiCoO₂ | Without | 92.1 | 59.6 | 0 |
| example 2-1 | | | polymer | | | |
| Comparative | 4.55 | | | 88.3 | 40.1 | 0 |
| example 2-2 | | | | | | |
| Comparative | 4.20 | | Polymer | 99.0 | 94.4 | 88.0 |
| example 2-3 | | | contained | | | |
| Comparative | | | Without | 98.9 | 94.0 | 87.7 |
| example 2-4 | | | polymer | | | |

TABLE 2

| | | | | Discharge capacity | | |
|---|---|---|---|---|---|---|
| | | | | retention ratio (%) | | |
| | Charging | Cathode active | | 100th | 200th | 400th |
| | voltage (V) | material | Electrolyte | cycle | cycle | cycle |
| Example 3-1 | 4.40 | LiCo_{0.98}Al_{0.01}Mg_{0.01}O₂ | Polymer | 97.5 | 95.4 | 89.3 |
| Example 3-2 | 4.55 | | contained | 95.7 | 92.1 | 87.2 |
| Comparative | 4.40 | LiCo_{0.98}Al_{0.01}Mg_{0.01}O₂ | Without | 92.4 | 62.5 | 0 |
| example 3-1 | | | polymer | | | |
| Comparative | 4.55 | | | 90.3 | 41.4 | 0 |
| example 3-2 | | | | | | |
| Comparative | 4.20 | | Polymer | 99.1 | 95.0 | 90.0 |
| example 3-3 | | | contained | | | |
| Comparative | | | Without | 99.0 | 94.2 | 88.6 |
| example 3-4 | | | polymer | | | |

As shown in Tables 1 and 2, as in Examples 1-1 and 1-2, in the case that the charging voltage was over 4.20 V, the discharge capacity retention ratio could be significantly improved in Examples 2-1, 2-2, 3-1, and 3-2 using the polymer containing vinylidene fluoride as a component than in Comparative examples 2-1, 2-2, 3-1, and 3-2 using the electrolytic solution directly. Meanwhile, in Comparative examples 2-3, 2-4, 3-3, and 3-4, in which the charging voltage was 4.20 V, the discharge capacity retention ratios were almost equal to each other regardless of usage of the polymer.

That is, it was found that as long as the polymer containing vinylidene fluoride as a component was used, similar effect could be obtained even when other cathode active material was used.

### Examples 4-1 to 4-10, 5-1 to 5-9, 6-1, and 6-2

Secondary batteries were fabricated in the same manner as in Examples 1-1 and 1-2, except that in Examples 4-1 to 4-9, as a cathode active material, a mixture of LiCoO₂ powder and LiNi_{0.33}Co_{0.33}Mn_{0.33}O₂ powder was used and the predetermined charging voltage was 4.40 V, and except that in Example 4-10, as a cathode active material, LiNi_{0.33}Co_{0.33}Mn_{0.33}O₂ powder was used and the predetermined charging voltage was 4.40 V.

In Examples 5-1 to 5-9, secondary batteries were fabricated in the same manner as in Examples 1-1 and 1-2, except that as a cathode active material, a mixture of LiCoO₂ powder and LiNi_{0.33}Co_{0.33}Mn_{0.33}O₂ powder was used and the predetermined charging voltage was 4.55 V.

In Examples 6-1 and 6-2, secondary batteries were fabricated in the same manner as in Examples 1-1 and 1-2, except that as a cathode active material, a mixture of LiCo_{0.98}Al_{0.01}Mg_{0.01}O₂ powder and LiNi_{0.33}Co_{0.33}Mn_{0.33}O₂ powder was used and the predetermined charging voltage was 4.40 V or 4.55 V.

For the fabricated secondary batteries of Examples 4-1 to 4-10, 5-1 to 5-9, and 6-1 to 6-2, charge and discharge were performed in the same manner as in Examples 1-1 and 1-2, and the discharge capacity retention ratio of each cycle to the discharge capacity at the first cycle was examined. The predetermined voltage value in charging was 4.40 V in Examples 4-1 to 4-10 and 6-1; and 4.55 V in Examples 5-1 to 5-9 and 6-2. The obtained results are shown in Tables 3 to 5 together with the results of Examples 1-2, 2-1, 2-2, 3-1, and 3-2.

TABLE 3
Charging voltage: 4.40 V

| | | | Discharge capacity | | |
|---|---|---|---|---|---|
| | Composition of | | retention ratio | | |
| | cathode active | | (%) | | |
| | material (weight ratio) | | 100th | 200th | 400th |
| | LiCoO₂ | LiNi_{0.33}Co_{0.33}Mn_{0.33}O₂ | cycle | cycle | cycle |
| Example 2-1 | 10 | 0 | 98.6 | 92.1 | 84.0 |
| Example 4-1 | 9 | 1 | 98.8 | 91.8 | 84.0 |
| Example 4-2 | 8 | 2 | 98.3 | 91.7 | 83.9 |
| Example 4-3 | 7 | 3 | 98.0 | 91.7 | 84.3 |
| Example 4-4 | 6 | 4 | 98.1 | 91.9 | 84.5 |
| Example 4-5 | 5 | 5 | 97.9 | 92.0 | 84.6 |
| Example 4-6 | 4 | 6 | 98.6 | 91.8 | 84.5 |
| Example 4-7 | 3 | 7 | 98.0 | 92.1 | 84.7 |
| Example 4-8 | 2 | 8 | 98.4 | 92.0 | 84.6 |
| Example 4-9 | 1 | 9 | 98.3 | 92.4 | 84.8 |
| Example 4-10 | 0 | 10 | 98.5 | 93.0 | 84.9 |

TABLE 4
Charging voltage: 4.55 V

| | | | Discharge capacity | | |
|---|---|---|---|---|---|
| | Composition of cathode active | | retention ratio (%) | | |
| | material (weight ratio) | | 100th | 200th | 300th |
| | LiCoO₂ | LiNi_{0.33}Co_{0.33}Mn_{0.33}O₂ | cycle | cycle | cycle |
| Example 2-2 | 10 | 0 | 90.6 | 84.0 | 76.0 |
| Example 5-1 | 9 | 1 | 90.6 | 84.3 | 76.2 |
| Example 5-2 | 8 | 2 | 90.9 | 84.0 | 76.1 |
| Example 5-3 | 7 | 3 | 91.1 | 84.8 | 76.8 |
| Example 5-4 | 6 | 4 | 92.2 | 85.1 | 77.6 |
| Example 5-5 | 5 | 5 | 92.1 | 85.2 | 77.3 |
| Example 5-6 | 4 | 6 | 92.7 | 85.8 | 78.6 |
| Example 5-7 | 3 | 7 | 93.1 | 87.0 | 79.9 |
| Example 5-8 | 2 | 8 | 93.8 | 87.9 | 81.0 |
| Example 5-9 | 1 | 9 | 94.3 | 90.0 | 81.5 |
| Example 1-2 | 0 | 10 | 94.7 | 90.2 | 82.0 |

TABLE 5

| | | Composition of cathode | | Discharge capacity | | |
|---|---|---|---|---|---|---|
| | Charging | active material | | retention ratio (%) | | |
| | voltage | (weight ratio) | | 100th | 200th | 400th |
| | (V) | LiCo_{0.98}Al_{0.01}Mg_{0.01}O₂ | LiNi_{0.33}Co_{0.33}Mn_{0.33}O₂ | cycle | cycle | cycle |
| Example 3-1 | 4.40 | 10 | 0 | 97.5 | 95.4 | 89.3 |
| Example 6-1 | | 7 | 3 | 96.9 | 94.5 | 89.6 |
| Example 3-2 | 4.55 | 10 | 0 | 95.7 | 92.1 | 87.2 |
| Example 6-2 | | 7 | 3 | 96.1 | 93.5 | 86.0 |

As shown in Tables 3 to 5, even when the mixture of cathode active materials was used, results equal to of Examples 1-2, 2-1, 2-2, 3-1, and 3-2, in which one cathode active material was singly used could be obtained. That is, it was found that as long as the polymer containing vinylidene fluoride as a component was used, similar effect could be obtained even when the mixture of cathode active materials was used.

The present invention has been described with reference to the embodiment and the examples. However, the present invention is not limited to the foregoing embodiment and the foregoing examples, and various modifications may be made. For example, in the foregoing embodiment and the foregoing examples, descriptions have been given of the case using lithium as an electrode reactant. However, the present invention can be applied to the case using other Group 1A element such as sodium (Na) and potassium (K), a Group 2A element such as magnesium and calcium (Ca), other light metal such as aluminum, or an alloy of lithium or the foregoing as well, and similar effects can be thereby obtained. Then, for the anode active material, the anode material as described in the foregoing embodiments can be similarly used.

Further, in the foregoing embodiment and the foregoing examples, descriptions have been given of the case, in which the separator 15 and the electrolyte 16 are provided between the cathode 13 and the anode 14. However, when sufficient insulation can be secured by, for example, mixing an insulative filler with an electrolyte, the separator 15 may be omitted.

Further, in the foregoing embodiment and the foregoing examples, descriptions have been given of the secondary battery having a spirally wound structure, in which the cathode 13 and the anode 14 are layered and wound. However, the present invention can be similarly applied to the secondary battery having a structure in which a cathode and an anode are folded, or a structure in which a cathode and an anode are layered. In addition to the film package member, a can package member can be also used. Further, the present invention can be similarly applied to a secondary battery such as a so-called coin type secondary battery, a button type secondary battery, a cylinder type seondary battery, and a square type secondary battery. Furthermore, the present invention can be applied to primary batteries in addition to the secondary batteries.

It should be understood by those skilled in the art that various modification, combinations, sub-combinations and alternations may occur depending on design requirements and other factors insofar as they are within the scope of the appended claims or the equivalents thereof.

What is claimed is:

1. A battery in which a cathode and an anode are oppositely arranged with an electrolyte in between,
wherein an open circuit voltage in a full charge state per a pair of the cathode and the anode is in the range from 4.25 V to 6.00 V, and
the electrolyte contains an electrolytic solution and a polymer containing vinylidene fluoride as a component.

2. The battery according to claim 1, wherein the polymer contains a copolymer containing vinylidene fluoride and hexafluoropropylene as a component.

3. The battery according to claim 2, wherein the copolymerization amount of hexafluoropropylene in the copolymer is 7 wt % or less.

4. The battery according to claim 1, wherein the cathode contains at least one from the group consisting of lithium complex oxides shown in Chemical formula 1, Chemical formula 2, or Chemical formula 3.
Li_{f}Mn_{(1-g-h)}Ni_{g}M1ₕO₍₂₋ⱼ₎Fₖ (Chemical formula 1)
wherein M1 represents at least one from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); and f, g, h, j, and k are values in the range of 0.8≦f≦1.2, 0≦g≦0.5, 0≦h≦0.5, g+h<1, −0.1≦j≦0.2, and 0≦k≦0.1.
LiₘNi₍₁₋ₙ₎M2ₙO₍₂₋ₚ₎F_{q} (Chemical formula 2)
wherein M2 represents at least one from the group consisting of cobalt, manganese, magnesium, aluminum, boron, titanium, vanadium, chromium, iron, copper, zinc, molybdenum, tin, calcium, strontium, and tungsten; and m, n, p, and q are values in the range of 0.8≦m≦1.2, 0.005≦n≦0.5, −0.1≦p≦0.2, and 0≦q≦0.1.
LiᵣCo₍₁₋ₛ₎M3ₛO₍₂₋ₜ₎Fᵤ (Chemical formula 3)
wherein M3 represents at least one from the group consisting of nickel, manganese, magnesium, aluminum, boron, titanium, vanadium, chromium, iron, copper, zinc, molybdenum, tin, calcium, strontium, and tungsten; and r, s, t, and u are values in the range of 0.8≦r≦1.2, 0≦s<0.5, −0.1≦t≦0.2, and 0≦u≦0.1.
